(19) United States
(12) Patent Application Publication
(10) Pub. No.: US 2003/0015238 A1
(43) Pub. Date: Jan. 23, 2003

(54) Diesel engine fuel pressure regulator

(76) Inventor: Thomas B. Martin, Eldorado Hills, CA (US)

Correspondence Address: GLENN C. BROWN, PC, 777 NW WALL STREET, SUITE 308, BEND, OR, 97701, US

(21) Appl. No.: 10/175,394

(22) Filed: Jun. 18, 2002

Related U.S. Application Data
(60) Provisional application No. 60/299,317, filed on Jun. 18, 2001.

(51) Int. Cl. F16K 35/00

(52) U.S. Cl. 137/384

(57) ABSTRACT

A pressure regulator having a first orifice that permits a flow of liquid and maintains a back pressure in the supply line, and a second orifice that provides a second, greater flow of fluid responsive to a pressure increase in the inlet line.

### CROSS REFERENCE TO RELATED APPLICATION

This application is a continuation of U.S. provisional patent application Serial No. 60/299,317, filed on Jun. 18, 2001. The priority of the prior application is expressly claimed and its disclosure is hereby incorporated by reference in its entirety.

### BACKGROUND OF THE INVENTION

This invention relates to diesel engines, and in particular to fuel pressure regulators for use in conjunction with diesel engines.

Diesel engines are widely used in trains and trucks. Most modern diesel engines use electronic unit injection to provide fuel to the engine. Fuel supply systems for diesel engines that incorporate electronic unit injection require excess fuel flow and pressure to cool the injectors and to suppress cavitation. Cavitation is the formation and collapse of small amounts of fuel, and typically occurs as the fuel is accelerated along an interior pump surface. Cavitation is harmful to the fuel pump because it causes high rates of erosion of the interior surface of the pump. It is common practice to use either an engine driven positive displacement fuel pump whose output varies with engine rpm, or a constant speed electric motor driven pump to supply constant fuel flow.

To maintain the required back-pressure in the system either a fixed orifice restriction, or a pressure regulating mechanism is used at the end of the fuel line where the excess fuel not burned by the engine is returned to the fuel tank. The fixed orifice has the advantage of simplicity and reliability, but at best achieves poor back-pressure regulation. The pressure regulating mechanism is more accurate, but is subject to failure modes and effects that may cause problems with the operation of the engine. The pressure regulating mechanism may also be cause pump priming problems on system startup since, in the absence of pressure, it is basically a closed valve. As such it may not allow the system to vent properly while priming. Another problem with the pressure regulating mechanism is cavitation erosion associated with high escape velocities into regions of low static pressure where vapor bubbles can form and subsequently collapse with detrimental effect on nearby surfaces.

The object of the present invention is to provide an improved pressure regulating mechanism for a diesel engine fuel system that combines the simplicity of the fixed orifice with the accuracy of the pressure regulator while at the same time reducing the detrimental effect of cavitation and potential failure modes.

Another object of the invention is to provide a fuel pressure regulating mechanism for a diesel engine that will maintain substantially constant fuel pressure over the full range of fuel flow provided by an engine driven fuel pump.

Still another object of the invention is to provide such a system that is cost-effective, highly reliable and simple to produce.

Yet another object of the invention is to provide such a system that is based on standard hydraulic fittings such as a coupling or an elbow.

The invention includes two different sized orifices in series with a pressure regulating mechanism interposed between them. The intermediate pressure regulating mechanism provides a fuel bypass around the first orifice and introduces an additional flow to the second orifice. The entire assembly is either contained within a standard hydraulic fitting or is installed into a suitable housing designed for the purpose.

### BRIEF DESCRIPTION OF THE DRAWINGS

FIG. 1 is a cross-sectional side view along line B-B of FIG. 5 showing a first embodiment of the invention, and showing the regulator in a position wherein flow of fuel at low engine operating speeds is directed entirely through a first orifice.

FIG. 2 is a second cross-sectional side view of the embodiment shown in FIG. 1, and showing the regulator in a position wherein flow of fuel at higher engine operating speeds is directed through the first orifice and a second orifice.

FIG. 3 is a cross-sectional view of another preferred embodiment wherein the orifice and sealing surfaces are formed of an insert of a material different from that of the orifice plate and piston.

FIG. 4 is a cross-sectional view of another embodiment of the invention wherein the flow of fuel at low flow rates is regulated by a predetermined gap between the piston and a sealing surface.

FIG. 5 is an end elevational view from the inlet side of the regulator.

FIG. 6 is an end elevational view from the outlet side of the regulator.

### DETAILED DESCRIPTION OF THE PREFERRED EMBODIMENTS

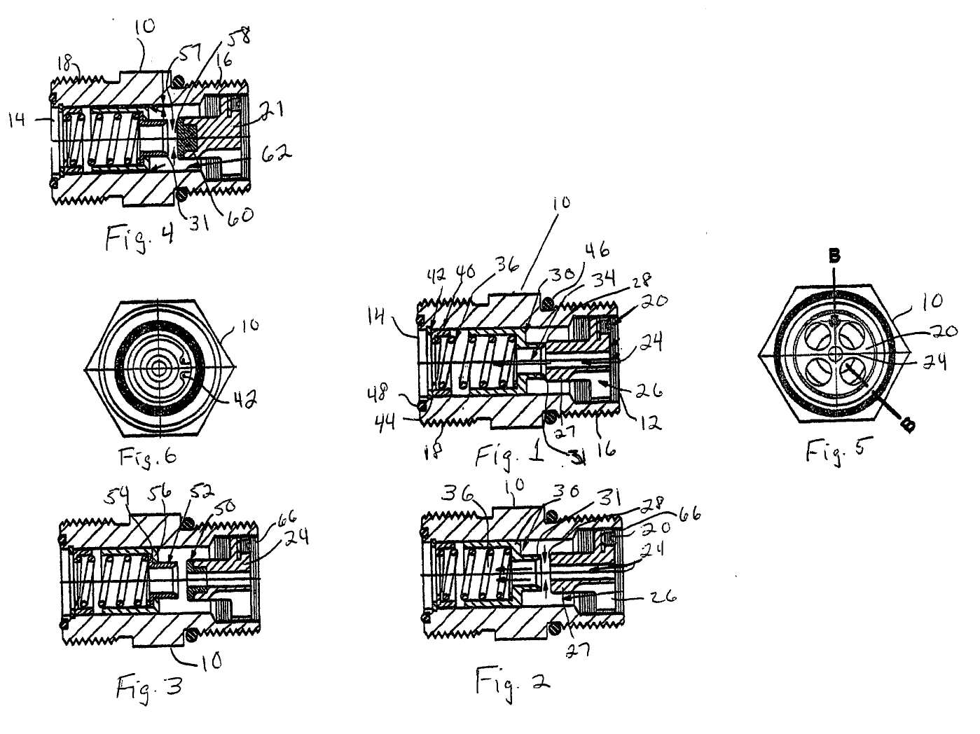

Referring now to FIGS. 1-6, a pressure regulating valve according to the invention is shown generally at 10. Valve 10 includes a body having an inlet 12 and an outlet 14. In preferred embodiments, the body is modified from a standard hydraulic fitting such as an elbow or connector. Each end of the outer surface of valve 10 includes threads 16 and 18, and is thereby plumbed into the fuel system. An orifice plate 20 is threaded into the inlet 12, and is and is locked in position by locking screw 22. Orifice plate 20 includes a central orifice 24 extending longitudinally through the orifice plate. Orifice plate 20 also includes a surface that, together with the interior surface of inlet 20, defines a fluid passage 26 through which fuel can bypass central orifice 24 to accommodate high flow conditions, as described in greater detail below. Orifice plate 24 terminates in a distal annular portion 27 that defines an annular sealing surface 28.

An annular piston 30 is slidably mounted in the valve body. A first end of piston 30 includes a second orifice 34 that is in communication with the valve outlet 14. In the preferred embodiment, the second orifice 34 is larger than central orifice 24 as will be explained in greater detail below. The first end of piston 30 terminates in an annular sealing surface 31. In one operative position (FIG. 1) sealing surface 31 registers in sealing engagement with annular sealing surface 28. Spring 36 is mounted in piston 30 and biases piston 30 toward the first operative position. In a second operative position (FIG. 2) sealing surface 31 is spaced apart from annular sealing surface 28, and permits fuel to flow from fluid passage 26 to outlet 14, bypassing central orifice 24. Spring 36 is positioned within piston 30, and bears against shoulder 38 of piston 30. Spring 36 is retained in the valve body by retainer 40 and circlip 42 that is engaged with groove 44. Valve 10 includes inlet sealing ring 46 and outlet sealing ring 48 for sealing engagement with the mating surfaces of the fuel system connections (not shown).

In an alternate embodiment shown in FIG. 3, an orifice insert 50 is mounted in orifice plate 24. Insert 50 can be of any desired material, and provides the option of varying the orifice size for specific applications. Insert 50 also permits replacement of the orifice without the need to replace the entire orifice plate. In this embodiment, piston 30 includes an orifice insert 52 that, like insert 50, can be of a different material than piston 30, can be varied in size, and can be replaced without replacing the entire piston assembly. In this embodiment, spring 36 bears against a flange 54 on insert 52. Flange 54 in turn bears against flange 56 of piston 30.

In yet another embodiment (FIG. 4) central orifice 24 is dispensed with altogether. Instead of central orifice 24 being provided to regulate low pressure flow, piston 30 is positioned in its first position to provide a predetermined space 57 between sealing surface 31 of piston 30 and a continuous sealing surface 58 of an insert 60. Insert 60 is mounted on inlet plate 21. Insert 60 and inner surface 62 of valve 10 define a fluid flow path 64 through which fuel flows at a restricted flow rate through space 57, second orifice 34, and through outlet 14 of the valve.

Having described the structure of several preferred embodiments, their operation will now be described.

Referring again to FIGS. 1 and 2, central orifice 24 is fixed in place and is sized to create the required back-pressure at the low fuel flow rate that the engine driven pump delivers at idle rpm. This is illustrated in FIG. 1. Fuel enters valve 10 through inlet 12. A predetermined amount of fuel flows through central orifice 24. At the same time, the restricted flow through central orifice 24 creates a predetermined back pressure in the inlet 12. Central orifice 24 also bypasses the pressure regulating mechanism to vent the fuel flow through to the second orifice 34 for priming. The second orifice 34 is located in piston 30, and is sized to create the required back-pressure at the fuel flow rate that exists at maximum rpm of the engine.

When the engine speed increases the increased flow from the pump causes the pressure drop through the central orifice 24 to exceed the pressure set by spring 36.

This causes piston 30 to move toward outlet 14, compressing spring 30 and opening an annular passage between the end of piston 30 and the annular sealing surface 28 (FIG. 2). Fuel then flows through this passage, bypasses the central orifice 24, and maintains the required back pressure on the fuel system. At the useful levels of power where the engine spends most of its operating time except for idling, the pressure drop through the second orifice raises the region of low static pressure in the pressure regulator to a value that substantially eliminates the effects of cavitation. When the engine approaches its maximum output the annular passage of the pressure regulator is wide open. At this point both the pressure regulator and the first orifice are substantially out of the picture and the system pressure is maintained solely by the second orifice.

As an added benefit, the pressure regulating mechanism also operates in a similar manner to regulate the system pressure during variations in flow due to fuel burned by the engine at any particular time.

During periods of idling all the available flow will be going through the smaller first orifice and passing directly through the larger second orifice. The pressure regulator is normally closed and inactive at this point. This is one situation where cavitation may still be an issue unless the pressure regulator is tightly sealed when closed. To this end it may be necessary to change the sealing materials used in the orifice plate and the piston to materials that promote better sealing. This is illustrated in FIG. 3.

For fuel systems that incorporate an electric motor driven fuel pump rather than an engine driven fuel pump the fuel flow is constant and equal to the specified flow required to operate the engine. Thus there is little need for the first orifice except for priming and for stabilizing the flow through the regulator assembly. In this case priming relief can be provided by other means, or by simply a loose-fitting pressure regulator piston as shown in FIG. 4.

The pressure regulator setting is adjustable over its useful range by means of the threaded recess 66 in the valve body 10 in which the corresponding threaded outer surface of the orifice plate 20 is engaged. The position of the orifice plate 20 and therefore the force of the spring can be adjusted by rotating the orifice plate 20. A locking screw is provided to prevent the orifice plate from moving after its position has been set.

While the invention has been described with reference to the foregoing preferred embodiments, those of skill in the art will appreciate that numerous changes in detail and arrangement are possible without departing from the scope of the following claims. For example, the invention has been described in the context of a diesel fuel system. However, the invention is not intended to be limited to diesel fuel systems, or even fuel systems, but could also find application in any fluid system requiring back-pressure regulation at varying flow rates.

What is claimed is:

1. A pressure regulator comprising:
a body having an inlet and an outlet;
surfaces defining a first orifice in communication with the inlet and a first sealing surface adjacent the first orifice;
surfaces defining a bypass around the first orifice and in communication with a first interior portion of the body;
an operable member slidingly mounted in the body, the operable member defining a second orifice in communication with the outlet, a second sealing surface, and a fluid pressure bearing surface, the fluid pressure bearing surface in communication with the bypass;
the operable member biased toward a first position wherein the second sealing surface is sealingly engaged with the first sealing surface and the second orifice is isolated from the bypass; and,
the operable member operable toward a second position wherein the second sealing surface is spaced apart from the first sealing surface and the second orifice is in communication with the bypass and the outlet.

2. A pressure regulator according to claim 1 wherein the surfaces defining a first orifice in communication with the inlet and a first sealing surface include:
an orifice plate mounted in the inlet, the orifice plate having a central orifice, a distal sealing surface adjacent the central orifice, and surfaces defining a bypass in communication with the inlet and the first interior portion of the body.

3. A pressure regulator according to claim 1 wherein the operable member includes a piston having an orifice formed in a first end, a sealing surface adjacent the second orifice sized to engage the first sealing surface adjacent the first orifice, and an interior shoulder.

4. A pressure regulator according to claim 1 wherein the operable member includes a spring engaged with the pressure regulator body and the operable member interior shoulder.

5. A pressure regulator according to claim 1 wherein the operable member includes an insert defining the second orifice.

6. A pressure regulator comprising:
a body having an inlet and an outlet;
the inlet including surfaces defining a first surface in communication with the inlet;
an operable member slidingly mounted in the body, the operable member defining a second orifice in communication with the outlet, an annular surface adjacent the second orifice, and a fluid pressure bearing surface, the fluid pressure bearing surface in communication with the inlet;
the operable member biased toward a first position wherein the annular surface adjacent the second orifice is spaced apart a first predetermined distance from the surfaces and defining a flow restrictive opening in communication with the second orifice; and,
the operable member operable toward a second position wherein the annular surface adjacent the second orifice is spaced apart a second, greater distance from the first surface.

7. A pressure regulator according to claim 6 wherein the operable member includes a piston having an orifice formed in a first end, and an interior shoulder.

8. A pressure regulator according to claim 6 wherein the operable member includes a spring engaged with the pressure regulator body and the operable member interior shoulder.

9. A pressure regulator according to claim 1 wherein the operable member is operable to the second position responsive to an increase in inlet pressure.

10. A pressure regulator according to claim 6 wherein the operable member is operable to the second position responsive to an increase in inlet pressure.

11. A pressure regulator according to claim 1 wherein the body is a standard hydraulic fitting.

12. A pressure regulator according to claim 6 wherein the body is a standard hydraulic fitting.
